(19) United States
(12) Patent Application Publication
(10) Pub. No.: US 2019/0390971 A1
(43) Pub. Date: Dec. 26, 2019

(54) DETERMINING CUMULATIVE ESTIMATED TIME FOR REQUESTED SERVICES

(71) Applicant: Uber Technologies, Inc., San Francisco, CA (US)

(72) Inventors: Karapet Shaginyan, San Francisco, CA (US); Seth Alan Woolley, Portland, OR (US)

(21) Appl. No.: 16/017,890

(22) Filed: Jun. 25, 2018

(51) Int. Cl. G01C 21/34; G01C 21/36; G08G 1/0968

(52) U.S. Cl. CPC G01C 21/3492; G08G 1/096844; G01C 21/3617; G01C 21/3438

(57) ABSTRACT

Various embodiments determine a set of estimated times of a service, being performed by a service providing user (a provider) at the request of another user (requester), using one or more cumulative estimated times. In particular, a computing device, such as a requester's client device or a backend server supporting backend operations of a service arrangement software platform, uses one or more cumulative estimated times to determine one or more estimated times in connection with a provider's performance of a requested service as the provider traverses (e.g., travels) a geographic route in connection with the requested service. The use of the cumulative estimated times enables the computing device to continue to determine and update the one or more estimated times with or without the availability of update data regarding the provider's current geographic position.

### TECHNICAL FIELD

The described embodiments generally relate to geographic positioning and, more particularly, to systems, methods, and machines for determining one or more estimated times with respect to a geographic route associated with a requested service, such as for a transportation service.

### BACKGROUND

Today's networked computer systems can facilitate or otherwise support arrangements between multiple users (e.g., of a service arrangement software platform operating on one or more server devices) whereby a first user (hereafter, a provider user, servicer provider, or provider) can provide a second user (hereafter, a requester user, service requester, or requester) with a service requested by the second user. Examples of requested services include, without limitation, a ride service, a ride-sharing service, a delivery service, or some other transportation service that requires navigation from one geographic location to another using a geographic map. Since certain requested services at least involve the provider traveling to the requester, generating a geographic route (e.g., navigational route) from the provider's geographic location to the requester's geographic location is a key component for execution of the requested service, as is updating the geographic route as the provider's geographic location changes relative to the geographic route. This geographic route (along with initial estimated times of arrival for one or more points along the geographic route) may be initially generated by a request (e.g., call) to a geographic route planning engine (e.g., of the service arrangement software platform) that is usually remote from the client devices of the provider and the requester.

Additionally, once the request service has been assigned to the provider for execution and a geographic route has been generated, another key component is providing the requester with accurate (or fairly accurate) time estimate information regarding the requested service, such as an estimated time of arrival (ETA) of the provider as they travel (e.g., navigate) along the geographic route to perform the requested service. For instance, where a provider is providing a ride service to a requester, the requester (or the service arrangement software platform that dispatched the requested service to the provider) remains informed (e.g., in real-time) regarding the provider's ETA for picking up the requester from a pick-up location, and regarding the provider's ETA for dropping off the requester after the requester has been picked. In another instance, where a provider is picking up and then delivering an item to a requester, the requester (or the service arrangement software platform) remains informed (e.g., in real-time) regarding the provider's ETA for picking up the item from a pick-up location, and the provider's ETA for dropping off the item to the requester after the item has been picked. In both instances, the provider may be performing one or more requested services on behalf of other requesters and, as such, the performance of those other requested services can impact the time estimate information for the requested service the provider is executing for a first requester.

Presently, providing time estimate information regarding a requested service often involves a provider's client device (e.g., provider's smartphone) periodically sending or otherwise providing a requester's client device (e.g., requester's smartphone) with data regarding the provider's current position or geographic location. As such, keeping the time estimate information up-to-date can be an issue in instances when data regarding the provider's current position or geographic location is unavailable (e.g., temporarily or intermittently) or is not received in a timely manner (e.g., according to an expected refresh rate so that the time estimate information can be refreshed accordingly). Furthermore, keeping such time estimate information up-to-date can also involve multiple requests (e.g., calls) to a geographic route planning engine (e.g., of the service arrangement software platform) to generate updated geographic routing with updated travel estimated times of arrival (ETAs), which are used to update time estimate information based on the provider's current position/geographic location. The multiple geographic route planning engine requests (e.g., periodic requests for each data update) not only take up computing device resources (e.g., server processing, server memory, battery power of the provider and requester mobile client devices, etc.), but also result in additional latencies when updating time estimate information.

### BRIEF DESCRIPTION OF THE DRAWINGS

Various ones of the appended drawings merely illustrate various embodiments of the present disclosure and cannot be considered as limiting its scope.

FIG. 1 is a block diagram of a system environment for a networked computer system, in accordance with some embodiments.

FIG. 2 is a block diagram illustrating an example cumulative estimated time module for determining estimated times, in accordance with some embodiments.

FIG. 3 illustrates an example geographic route line operated upon by some embodiments.

FIGS. 4A-4C provide a diagram illustrating interactions between computing devices, in accordance with some embodiments.

FIG. 5 is a flowchart illustrating an example method for determining estimated times, in accordance with some embodiments.

FIG. 6 is a block diagram illustrating an example mobile device used to implement some embodiments.

FIG. 7 is a diagrammatic representation of a machine in the form of a computer system within which a set of instructions may be executed for causing the machine to perform any one or more of the methodologies discussed herein, in accordance with some embodiments.

The headings provided herein are merely for convenience and do not necessarily affect the scope or meaning of the terms used.

### DETAILED DESCRIPTION

The description that follows describes systems, methods, techniques, instruction sequences, and computing machine program products for determining and presenting a set of estimated times of a service, being performed by a service providing user (a provider) at the request of another user (a requester), using one or more cumulative estimated times. In the following description, for purposes of explanation, numerous specific details are set forth in order to provide an understanding of various embodiments of the inventive subject matter. It will be evident, however, to those skilled in the art that embodiments of the inventive subject matter can be practiced without these specific details. In general, well-known instruction instances, protocols, structures, and techniques have not been shown in detail.

According to various embodiments, a computing device, such as a requester's client device (hereafter, requester client device) or a computing device supporting backend operation of a service arrangement software platform, uses one or more cumulative estimated times to determine one or more estimated times in connection with a provider's performance of a requested service as the provider traverses (e.g., travels) a geographic route in connection with the requested service. The computing device may maintain (e.g., store and update) the one or more cumulative estimated times locally at the computing device. For some embodiments, the cumulative estimated times are updated (e.g., automatically and periodically) based on update data regarding the provider's current position or geographic location. Such provider update data are provided (e.g., generated) by a provider's mobile client device (hereafter, provider client device) as the mobile client device performs the requested service (e.g., travel) and are provided on a periodic basis. In instances when the provider update data is not available to the computing device or is not provided to the computing device in a timely manner (e.g., according to an expected time period), various embodiments enable the computing device to continue to update the cumulative estimated times without the provider update data. In doing so, various embodiments permit the computing device to continue to determine (e.g., approximately determine) the one or more estimated times associated with the requested services using the cumulative estimated times even when provider update data is unavailable. For example, provider update data may not be available to the computing device when the provider's mobile client device fails to communicate the provider update data over a communications network or when the aforementioned computing device (e.g., requester's client device) fails to receive the provider update data over a communications network. Additionally, various embodiments obviate the need for the computing device to make requests (e.g., calls) to a geographic routing planning engine (e.g., of the service arrangement software platform) to generate updated geographic routes with updated estimated travel times for segments of the geographic routes (e.g., ETAs). In the event that provider update data that was previously unavailable becomes available again, the computing device resumes determining one or more estimated times for the requested service based on the provider update data.

According to various embodiments, a computing device maintains a set of cumulative estimated times with respect to a geographic route generated in connection with a requested service. The geographic route when generated (at least initially) can include a geographic route line (e.g., by a geographic routing planning engine) comprising a set of route legs and a set of waypoints (e.g., start and end waypoints), can include estimated travel times (e.g., ETAs) for the provider to travel route legs (e.g., segments) of the geographic route, and can include estimated wait times the provider will spend at waypoints of the geographic route (e.g., time spent at a waypoint to complete service-related tasks, such as a drop-off or pick-up of a rider requesting a ride service). As used herein, a route leg can include one or more route segments (e.g., roads, streets, sidewalks, water ways, walking paths) and one or more nodes that represent navigations changes (e.g., turns) between route segments. The set of cumulative estimated times can be used to determine how much estimated time remains for the provider to traverse a particular portion of the geographic route line, such as time remaining for the provider to travel a route leg (e.g., one or more route segments and nodes between route segments) or time the provider will spend at a particular waypoint of the geographic route line. For instance, the set of cumulative estimated times may be maintained by a data structure (e.g., cumulative estimated time of arrival (ETA) data structure) comprising a sequence of estimated times (e.g., sequence of ETAs) for traversing waypoints (e.g., represented by vertices of a geographic route line) or route legs (e.g., represented by edges of a geographic route line) of the geographic route line. The geographic route line represents a navigational route (according to a geographic map) that is traversed by the provider to travel from a start waypoint to an end waypoint in connection with a requested service. The navigational route, which may include roads, streets, highways, sidewalks, waterways, bodies of water, and the like, depends on the one or more modes of transportation (e.g., car, truck, motorcycle, train, bus, airplane, bicycle, watercraft, walking) being used by the provider in performing the requested service.

The following describes features of an example implementation of various embodiments. The following description in no way limits features of other embodiments. Given a geographic route comprising a route line (e.g., geographic route line) with n portions (e.g., route leg and waypoints), a cumulative estimated time data structure may list estimate times as follows:

cET=[ET₀,ET₁, . . . ,ETᵢ, . . . ,ETₙ₋₁],

where cET[i] represents the estimated amount of time for the provider to spend with respect to the route portion i before the route portion i is considered traversed by the provider. For example, the cumulative estimated time data structure may comprise cET[i]=[6, 10, 6, 8, 2], where the scalar values [6, 10, 6, 8, 2] respectively correspond to route portions 0, 1, 2, 3, 4, and 5 of the geographic route line, which can be interpreted as 6, 10, 6, 8, and 2 seconds (or minutes) for the provider to spend (e.g., traveling or waiting) with respect to route portions before they are respectively considered traversed by the provider. For some embodiments, the cumulative estimated time data structure includes a probability (e.g., ETA probability) for at least one cumulative estimated time being used to determine an estimated time remaining in connection with the requested service, where the probability represents a confidence level value of the cumulative estimated time.

Though various embodiments are described herein with respect to estimated times (e.g., ETAs), for some embodiments, confidence level values are used in place of, or in addition to, cumulative estimated times. For instance, in place of an estimated time, an embodiment may use a set of estimated time ranges having an associated confidence interval (e.g., 25/75, 10/90); a set of histograms of likely times, a set of standard deviations, or the like, from which a cumulative result may be produced comprising a statistical addition of those components and preserves the same confidence data structure (e.g., cumulative estimated time ranges, cumulative histograms, or cumulative standard deviations).

Assume that a requester client device is using the cumulative estimated time data structure to determine one or more estimated times in connection with a requested service being performed by a provider (on behalf of a requester), and a geographic route line is displayed (e.g., as a poly-line) to the requester on the requester client device (e.g., on a graphical user interface thereof). As the provider makes progress along the geographic route line, the provider client device transmits periodically (e.g., every four seconds) to the requester client device update data regarding the provider's position (e.g., relative to the geographic route line or geographic position) or geographic location, either directly from the requester client device or via a backend server (e.g., one supporting the service arrangement software platform). For example, the update data regarding the provider's position may comprise one or more of identification of a route portion (e.g., route leg or waypoint) of the geographic route line, a position of the provider relative to the route portion, or geographic coordinates. For instance, the update data may structure the provider's current position information as follows.
(identification of route portion, ratio of route portion completed, latitude, longitude)
   The identification of the route portion corresponds with the elements of the cET data structure. The ratio may comprise a fractional value. The latitude and longitude values may comprise GPS position.

When a requested service is assigned to a provider, a requester client device (e.g., via the service arrangement software platform) is provided with initial service-related data regarding the requested service. The initial service-related data can include the geographical route line for the requested service, and may further include initial estimated travel times from one point along the geographic route line to another point, such as ETAs for traveling from one waypoint to another of the geographic route line. The initial service-related data can include waypoint metadata for one or more waypoints of the geographical route line, where waypoint metadata describes a provider action with respect to a particular waypoint, such as a task (e.g., business function) to be performed at the particular waypoint in connection with the requested service (e.g., pick-up the requester, drop-off the requester, deliver an item). Additionally, the metadata may describe how long the provider is estimated to spend at the particular waypoint. Accordingly, a computing device initializes estimated times (e.g., estimated time values) in the cumulative estimated time data structure using the initial service-related data for the requested service.

Continuing with reference to the cumulative estimated time data structure comprising cET [i]=[6, 10, 6, 8, 2], assume cET [1] (e.g., 10 seconds) corresponds to a pick-up waypoint, and cET[4] (e.g., 2 seconds) corresponds to a drop-off waypoint with respect to a requested ride service. Accordingly, if the provider has made no progress with respect to the geographic route line, the requester client device determines the provider's ETAs for the pick-up and drop-off locations as follows.

Pick-up ETA=Σₙ₌₀¹cET[i]=16 seconds

Drop-off ETA=Σₙ₌₀⁴cET[i]=32 seconds

Assuming that the provider has made half progress with respect to the 0^{th} route portion (e.g., a route leg) of the geographic route line (i.e., corresponding to cET[0]), the provider client device(?) provides the following example update data: (0, 0.5, 37.222, −122.333). Based on this progress, the requester determines the provider's ETAs for the pick-up and drop-off locations as follows.

Pick-up ETA=(1−0.5)×cET[0]+Σₙ₌₁¹cET[i]=13 seconds

Drop-off ETA=(1−0.5)×cET[0]+Σₙ₌₁⁴cET[i]=29 seconds

Assuming that the provider has picked up the requester for the requested ride service and made 60% progress with respect to the 3^{rd} route portion (e.g., a route leg) of the geographic route line (i.e., corresponding to cET[2]), the provider client device(?) provides the following example update data: (3, 0.6, 37.888, −122.115). Based on this progress, the requester can determine the provider's ETAs for the drop-off location as follows.

Drop-off ETA=(1−1)×cET[0]+(1−1)×cET[1]+(1−0.6)×cET[2]+Σₙ₌₃⁴cET[i]=29 seconds

For some embodiments, a backend server (e.g., supporting the service arrangement software platform) performs similar operations with respect to a cumulative estimated time data structure, thereby enabling the backend server to determine one or more estimate times with respect to a geographic route line.

Assuming a provider client device provides update data comprising current position information structured as (j, k, lat, ing), and the computing device doing the ETA calculation (e.g., the requester client device or a backend server) has determined that the path of interest is between route portions b and e inclusively, where b<=e, the algorithm for performing ETA calculations is defined as follows.

```
ETA = 0
for i = b, b+1, ... , e:
  if i =j:
    ETA += (1 − k) * cET[i]
  else if i > j:
    ETA += cET[i]
return ETA
```

By using this algorithm for calculating ETAs based on cumulative estimated time data, a given embodiment updates ETAs of a provider with respect to a geographic routing line without making requests to a geographic route planning engine or module.

Additionally, the foregoing algorithm can be used for calculating ETAs based on cumulative estimated time data in instances when update data (regarding the provider's current position) from the provider client device is not available for use by a computing device performing ETA calculations, such as during network communication or device failure scenarios. Such scenarios can include, for example, where the provider client device fails to generate the update data, the provider client device fails to communicate the update data to the computing device performing the ETA calculations (e.g., the requester client device or a backend server), or the computing device performing the ETA calculations is unable to receive the update data. According to some embodiments, when the update data is not available to a computing device performing ETA calculations, the computing device (e.g., the requester client device or a backend server) estimates the provider's current position relative to the geographic route line based on a current position or geographic location of the requester client device (e.g., when the requested service is a ride service and the requester has already been picked up by the provider for the requested ride service). For instance, some embodiments determine a current position of the requester client device, determine the provider's position relative to the geographic route line based on the current position of the requester client device, and then use the determined provider's position relative to the geographic route line to determine one or more estimated times in connection with a requested service.

Additionally, for some embodiments, when the update data is not available to a computing device performing ETA calculations, the computing device (e.g., the requester client device or a backend server) estimates the provider's current position relative to the geographic route line based on elapsed time since the last time update data was received from the provider client device. As noted herein, a requester client device may receive update data directly from the provider client device or indirectly via a backend server that receives the update data directly from the provider client device. For instance, assuming that a provider client device provides update data periodically according to a predetermined period (e.g., 4 seconds), some embodiments determine time elapsed (e.g., 16 seconds) since the backend server last received update data from the requester client device (e.g., (1, 1.0, lat, ing)) at time t₀, by combining the predetermined time period and the time elapsed (e.g., 4 second+16 seconds=20 seconds). The resulting combined time can be applied to the provider's progress since the provider's last current position (e.g., (1, 1.0, lat, ing)) relative to the geographic route line.

For some embodiments, accuracy of determining (e.g., calculating) estimated times based on the cumulative estimated times is preserved when accounting for timing granularities for values of the cumulative estimated times. For example, using a timing granularity of seconds can be considered large and cause loss of accuracy with respect to determining estimated times. For some embodiments, the following algorithm can carry over residual values and preserve accuracy for determining estimated times for a particular granularity unit (e.g., seconds, milliseconds).

```
accumulation = 0
for i = 0, 1, ..., n-1:
  cET[i] = convertToGranularityUnit(cET[i])
  accumulation += cET[i] % 1
  if accumulation >= 1.0:
    cET[i] += 1
    accumulation −= 1
  cET[i] = Math.floor(cETA[i])
if accumulation > 0.5:
  cET[n-1] += 1
return cET
```

The algorithm as described above scans cET[i] from the beginning to the end, accumulates fractional components of the values in cET[i], and applies the resulting accumulated value (at least portions of it) to one or more elements in cET [i] when the accumulation value exceeds the boundary of the granularity unit. To illustrate, execution of the algorithm with respect to the cET[i]=[6.5, 10.5, 6, 8, 2] results in cET[i]=[6, 11, 6, 8, 2].

Reference will now be made in detail to embodiments of the present disclosure, examples of which are illustrated in the appended drawings. The present disclosure may, however, be embodied in many different forms and should not be construed as being limited to the embodiments set forth herein.

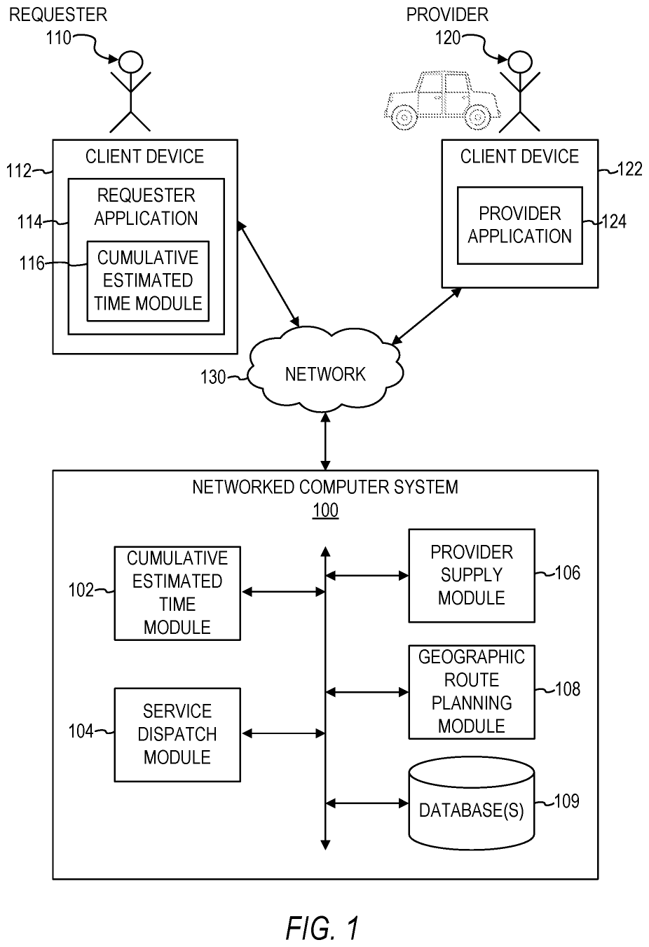

FIG. 1 is a block diagram of a system environment for a networked computer system 100, in accordance with some embodiments. In some embodiments, the networked computer system 100 coordinates delivery or transportation service of one or more persons, goods, or items for a service requester 110 (e.g., a rider) by a service provider 120 (e.g., a driver of a vehicle). The provider 120 uses a vehicle to provide the delivery or transportation service to the requester 110.

In some embodiments, the networked computer system 100 comprises a cumulative estimated time module 102, a service dispatch module 104, a provider supply module 106, a geographic route planning module 108, and one or more database(s) 109. These modules 102, 104, 106, and 108 and databases 109 are not native components of a generic computer system, and provide structures and functions beyond generic functions of a computer system, as further described below.

In some embodiments, the modules 102, 104, 106, and 108 and the database(s) 109 reside on a machine having a memory and at least one processor (not shown). In some embodiments, the modules 102, 104, 106, and 108 and the database(s) 109 reside on the same machine, while in other embodiments, one or more of the modules 102, 104, 106, and 108 and the database(s) 109 reside on separate remote machines that communicate with each other via a network (e.g., a network 130). It is contemplated that other configurations are also within the scope of the present disclosure.

In some embodiments, the requester 110 operates a client device 112 that executes a requester application 114 that communicates with the networked computer system 100. The requester 110 operates the requester application 114 to view information about the networked computer system 100, and to make a request for service from the networked computer system 100 for a particular service, such as a delivery or transportation service (e.g., “a trip”) of the requester 110 (and, optionally, additional persons) or items (e.g., cargo) needing transport. The requester application 114 determines an origin location (e.g., a pick-up location within an origin location), or the requester application 114 enables the requester 110 to specify the origin location (e.g., a pick-up location within an origin location) or a destination location (e.g., drop-off location within a destination location) associated with the requested service. An origin location and/or a destination location may be a location inputted by the requester 110 or may correspond to the current location of the requester client device 112 as determined automatically by a location determination module (not shown) in the requester client device 112, such as a global positioning system (GPS) component, a wireless networking system, or a combination thereof. For purposes of simplicity, as described herein, the origin location includes a pick-up location for service (i) determined by the requester application 114 (e.g., based on the current location of the requester client device 112 using a GPS component), (ii) specified or selected by the requester 110, or (iii) determined by the networked computer system 100. In some embodiments, the networked computer system 100 recommends the pick-up location to the requester 110 based on historical trip data associated with the origin location or the requester (e.g., requester has been picked up multiple time from a particular location).

According to examples herein, the requester client device 112 transmits a set of data to the networked computer system 100 over a network 130 in response to requester 110 input or operation of the requester application 114. Such data can be indicative of the requester's interest in potentially requesting service (e.g., before actually confirming or requesting the service). For example, the requester 110 launches the requester application 114 and specifies an origin location and/or a destination location to view information from the networked computer system 100 before making a decision on whether to request service. The requester 110 may want to view information about the average or estimated time of arrival for pickup by the provider 120, an estimated time to the destination, a corresponding cost, available service types, etc. Depending on implementation, the data includes the origin and/or destination location information, requester information (e.g., identifier), application information (e.g., version number), device identifier or type, etc. According to some examples, each time the requester 110 modifies the origin and/or destination location, the requester application 114 generates and transmits the data to the networked computer system 100.

The network 130 may be any network that enables communication between or among machines, databases, and devices (e.g., the networked computer system 100 and the client devices 112 and 122). Accordingly, the network 130 may be a wired network, a wireless network (e.g., a mobile or cellular network), or any suitable combination thereof. The network 130 may include one or more portions that constitute a private network, a public network (e.g., the Internet), or any suitable combination thereof. Accordingly, the network 130 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., a WiFi network or a WiMax network), or any suitable combination thereof. Any one or more portions of the network 130 may communicate information via a transmission medium. As used herein, “transmission medium” shall be taken to include any intangible medium that is capable of storing, encoding, or carrying instructions for execution by a machine, and includes digital or analog communication signals or other intangible media to facilitate communication of such software.

Once the requester 110 confirms or orders a service via the requester application 114, the requester application 114 generates data corresponding to a request for the service through the networked computer system 100 (e.g., a ride service request). In response to receiving a service request for transportation, the networked computer system 100 determines the average estimated time of arrival (ETA) at the pick-up location of providers 120 whose current location are within a threshold distance of the pick-up location (e.g., providers 120 who are all within one mile of the pick-up location). In some embodiments, in response to determining that the requester's ETA at the pick-up location is within a threshold amount of time of the average ETA of nearby available providers 120, the service dispatch module 104 of the networked computer system 100 uses information from the service request to match the requester 110 with a provider that the provider supply module 106 indicates as available (e.g., the provider 120). Depending on implementation, the service request can include information regarding the requester 110 or device information (e.g., a requester identifier, a device identifier), a service type (e.g., vehicle type), or selected service option, an origin location, a destination location, a payment profile identifier, a desired departure time, or other data. The service dispatch module 104 selects the provider 120 from a set of providers provided by the provider supply module 106, such as based on the provider's current location and status (e.g., offline, online, available) or information from the service request (e.g., service type, origin location, and/or destination location), to provide the service for the requester 110 (e.g., transport the requester 110 from the origin location to the destination location). In response to selecting an available provider (e.g., the provider 120), the service dispatch module 104 sends an invitation message to the provider client device 122 inviting the provider 120 to fulfill the service request.

In one embodiment, the networked computer system 100 periodically determines the requester's ETA at the pick-up location based on the topological and geospatial location of the requester client device 112. In some embodiments, the networked computer system 100 selects the provider 120 based on a comparison of the requester's ETA and the provider's ETA at the pick-up location. The networked computer system 100 may determine the provider's ETA to the pick-up location based on a geographic route planning generated by the geographic route planning module 108. For example, if the networked computer system 100 determines that the requester 110 is about three minutes away from the pick-up location, the service dispatch module 104 may select the provider 120, who is also about three minutes away even if other providers have a shorter ETA. If, after matching the requester 110 with the provider 120, the networked computer system 100 determines that the requester's ETA and the provider's ETA at the pick-up location vary by over a threshold amount of time, the networked computer system 100 can reassign the requested service to another available provider indicated by the provider supply module 106.

As shown, the requester application 114 includes a cumulative estimated time module 116 that enables the requester application 114, at the requester client device 112, to determine a set of estimated times of a service, being performed by the provider 120 at the request of the requester 110, using one or more cumulative estimated times. According to some embodiments, the requester application 114 (e.g., on behalf of the cumulative estimated time module 116) receives, from the networked computer system 100 over the network 130, initial service-related data associated with a requested transportation service being performed by the provider 120. Depending on the embodiment, the initial service-related data may describe a geographic route line (e.g., from a start waypoint to an end waypoint) associated with the requested service, where the geographic route line comprises a set of route legs connected by a set of waypoints. The initial service-related data describes a set of initial estimated travel times (e.g., ETAs) for how long it should take the provider client device 122 to travel the set of route legs. Additionally, the initial service-related data describes a set of estimated wait times for how long the provider client device 122 is estimated to spend at the set of waypoints. As noted herein, the geographic route line represents a navigational route the provider 120 can take during performance of the requested service for the requester 110. For some embodiments, at least some of the information included by the initial service-related data, such as the geographic route line, the set of initial estimated travel times, and the set of initial estimated wait times, is generated by the geographic route planning module 108 (e.g., at the request of the service dispatch module 104 or the provider supply module 106 after the provider 120 accepts an invitation to fulfill the requested service).

The cumulative estimated time module 116 of some embodiments generates cumulative estimated time data based on the initial service-related data. Depending on the embodiment, the cumulative estimated time data describes a set of estimated travel times for the provider 120 (and the provider client device 122) to travel the set of route legs of the geographic route line described by the initial service-related data. Additionally, cumulative estimated time data describes a set of estimated wait times that the provider 120 (and the provider client device 122) will spend at the set of waypoints of the geographic route line described by the initial service-related data. Further, for some embodiments, the cumulative estimated time data comprises a data structure (e.g., an array or list) that describes a sequence of estimated times (e.g., estimated travel times or estimated wait times) corresponding to different portions (e.g., route legs or waypoints) of the geographic routing line provided by the initial service-related data received from the networked computer system 100.

Based on the cumulative estimated time module 116, the requester application 114 of some embodiments expects to periodically receive route position update data that identifies a recent position of the provider client device 122 relative (e.g., along) the geographic route line described by the initial service-related data. The requester application 114 receives the route position update data directly from the provider client device 122 or indirectly through the networked computer system 100.

The cumulative estimated time module 116 monitors for whether a first route position update data is received at expected times (e.g., according to an expected rate). In response to the cumulative estimated time module 116 determining that the route position update data is received at an expected time, the cumulative estimated time module 116 determines a set of estimated remaining times for the geographic route line based on the cumulative estimated time data and the latest route position update data from the provider client device 122. The set of estimated remaining times can include, without limitation, an estimated travel time remaining for the provider 120 to travel a particular route leg of the geographic route line, and an estimated wait time remaining for the provider 120 to spend at a particular waypoint of the geographic route line. In response to the cumulative estimated time module 116 determining that the route position update data is not received at an expected time, the cumulative estimated time module 116 determines a set of estimated remaining times for the geographic route line based on the cumulative estimated time data and a geographic location of the requester client device 112 (e.g., after the requester 110 has been picked up and is traveling with the provider 120). Alternatively, in response to the cumulative estimated time module 116 determining that the route position update data is not received at an expected time, the cumulative estimated time module 116 determines a set of estimated remaining times for the geographic route line based on the cumulative estimated time data and an elapsed time (e.g., elapsed time since receipt of the last route position update from the provider client device 122). Once the set of estimated remaining times is determined by the cumulative estimated time module 116, the cumulative estimated time module 116 causes one or more estimated remaining times, in the set of estimated remaining times, to be displayed on the requester client device 112, such as on a graphical user interface on a display screen. For instance, the one or more estimated remaining times may be displayed in connection with one or more portions of a geographic route line.

The provider 120 operates a client device 122 executing a provider application 124 that communicates with the networked computer system 100 to provide information (e.g., from the provider supply module 106) indicating whether the provider 120 is available or unavailable to provide transportation services to requesters 110. The provider application 124 also presents information about the networked computer system 100 to the provider 120, such as invitations to provide service, navigation instructions, map data, etc. In one embodiment, the provider application 124 enables the provider 120 to provide information regarding availability of the provider 120 by logging into the networked computer system 100 and activating a setting (e.g., via the provider supply module 106) indicating that the provider 120 is currently available to provide service. The provider application 124 also provides (e.g., according to a predetermined time period) the networked computer system 100, the requester client device 112, or both the current position (e.g., relative to a geographic route line generated by the geographic route planning module 108) or geographic location of the provider 120 or the provider client device 122. Depending on the embodiment, the current position or location may be a location inputted by the provider 120 or may correspond to the current position or location of the provider client device 122 as determined automatically based on information from a location determination module (not shown) in the provider client device 122, for example, a GPS component, a wireless networking system, or a combination thereof. The provider application 124 further allows the provider 120 to receive, from the service dispatch module 104, an invitation message to provide a service for the requesting requester 110, and if the provider 120 accepts, the provider application 124 transmits an acceptance message to the service dispatch module 104. The service dispatch module 104 subsequently provides information about the provider 120 to the requester application 114. In another embodiment, the provider application 124 enables the provider 120 to view a list of current service requests and to select a particular service request to fulfill. The provider application 124 also receives routing information (e.g., generated by the geographic route planning module 108) from the networked computer system 100.

In some embodiments, the requester client device 112 and provider client device 122 are portable electronic devices such as smartphones, tablet devices, wearable computing devices (e.g., smartwatches), or similar devices. Alternatively, the provider client device 122 can correspond to an on-board computing system of a vehicle. Client devices typically have one or more processors, memory, touch screen displays, wireless networking system (e.g., IEEE 802.11), cellular telephony support (e.g., L TE/GSM/UMTS/CDMA/HSDP A, etc.), and location determination capabilities. The requester client device 112 and the provider client device 122 interact with the networked computer system 100 through client applications configured to interact with the networked computer system 100. The applications 114 and 124 of the requester client device 112 and the provider client device 122, respectively, present information received from the networked computer system 100 on a requester interface, such as a map of the geographic region, geographic routes, and the current position/geographic location of the requester client device 112 or the provider client device 122. The applications 114 and 124 running on the requester client device 112 and the provider client device 124 can determine the current position/location of the respective device and provide the current location to the networked computer system 100.

The networked computer system 100 is configured to provide a communicative interface between the requester application 114, the provider application 124, and the various modules and databases in the networked computer system 100. The networked computer system 100 is configured to receive provider availability status information and current location information from the provider application 124 and update the database(s) 109 with the availability status. The networked computer system 100 is also configured to receive service requests from the requester application 114 and create corresponding service records in the database(s) 109. According to an embodiment, a service record corresponding to a service request can include or be associated with a service ID, a requester ID, an origin location, a destination location, a service type, pricing information, or a status indicating that the corresponding service request has not been processed. According to one embodiment, when the provider 120 accepts the invitation message to service the service request for the requester 110, the service record is updated with the provider's information as well as the provider's location and the time when the service request was accepted. Similarly, location and time information about the service as well as the cost for the service are associated with the trip record.

In one embodiment, during the trip, the networked computer system 100 receives information (e.g., periodically) from the provider application 124 indicating the position (e.g., relative to a geographic route line) or location of the provider's vehicle and/or telematics information (e.g., indications of current speed, acceleration/deceleration, events, stops). The networked computer system 100 stores the information in the database(s) 109 and associates the information with the service record. For some embodiments, the networked computer system 100 uses the cumulative estimated time module 102 to periodically calculate the provider's ETA at the pick-up location, which may be subsequently provided to the requester application 114.

In some embodiments, the requester application 114 and the provider application 124 are configured to display map data indicating a specific geographic location of a place, as well as navigation instructions for the requester 110 using the requester application 114 on how to navigate (e.g., walk) to the specific geographic location of the place and navigation instructions for the provider 120 using the provider application 124 on how to navigate (e.g., drive) to the specific geographic location of the place. For example, the provider application 124 displays, on the client device 122 of the provider 120, a map that includes a graphic element that corresponds to the current location of the provider 120 or the client device 122 of the provider 120 and a graphic element that corresponds to the specific geographic location of a place associated with a service request, such as a place to pick up or drop off the requester 110 associated with the service request, as well as a geographic route from the current location of the provider 120 or the client device 122 of the provider 120 to the specific geographic location of the place associated with the service request. Similarly, the requester application 114 displays, on the client device 112 of the requester 110, a map that includes a graphic element that corresponds to the current location of the requester 110 or the client device 112 of the requester 110 and a graphic element that corresponds to the specific geographic location of the place associated with the service request, as well as a route from the current location of the requester 110 or the client device 112 of the requester 110 to the specific geographic location of the place associated with the service request. Additionally, one or more estimated times (e.g., the provider 120's ETA to a pick-up or drop-off location) may be determined (locally at the requester client device 112) by the cumulative estimated time module 116 and displayed by the requester application 114 on the map display.

For some embodiments, the cumulative estimated time module 102 enables the networked computer system 100 to perform operations similar to those enabled for the requester application 114 by the cumulative estimated time module 116. For instance, the cumulative estimated time module 102 enables the networked computer system 100 to determine a set of estimated remaining times for a geographic route line based on cumulative estimated time data (generated by the cumulative estimated time module 102) and an elapsed time (e.g., elapsed time since receipt of the last route position update from the provider client device 122). In this way, for some embodiments, the cumulative estimated time module 102 enables the networked computer system 100 to track one or more estimated times of the geographic route line based on one or more times in the set of estimated remaining times generated. The networked computer system 100 may use the one or more estimated times, for instance, to help improve dispatching of services (e.g., by the service dispatch module 104), or improve tracking of service provider availability (e.g., by the provider supply module 106).

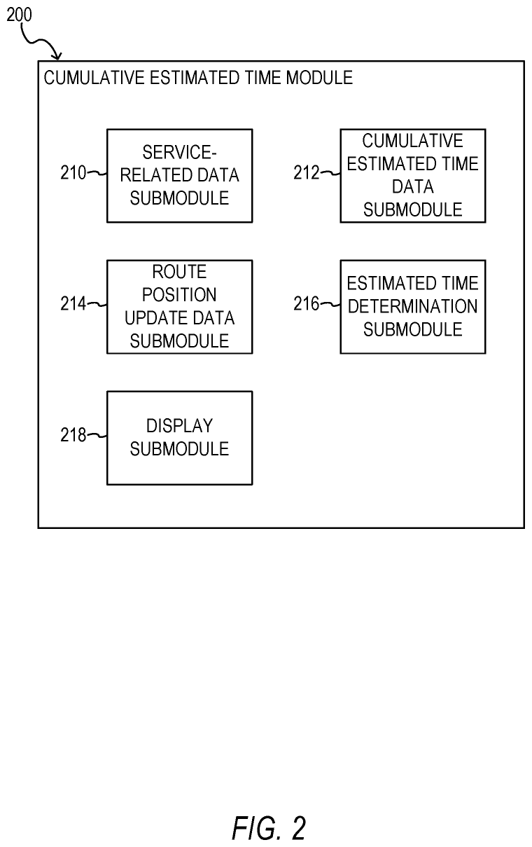

FIG. 2 is a block diagram illustrating an example cumulative estimated time module 200 for determining estimated times, in accordance with some embodiments. As shown, the cumulative estimated time module 200 includes a service-related data submodule 210, a cumulative estimated time data submodule 212, a route position update data submodule 214, an estimated time determination submodule 216, and a display submodule 218. Depending on the embodiment, the cumulative estimated time module 200 may differ in configuration from what is illustrated and described with respect to FIG. 2. For instance, the cumulative estimated time module 200 may comprise fewer modules than what is illustrated and described with respect to FIG. 2.

The service-related data submodule 210 enables or facilitates initial service-related data to be received and processed by the cumulative estimated time module 200. As noted herein, initial service-related data can include one or more of the geographical route line for the requested service; initial estimated travel times from one point along the geographic route line to another point (e.g., waypoint to waypoint ETAs); or waypoint metadata for one or more waypoints of the geographical route line.

The following describes an example data structure that may be included by the initial service-related data to describe a route leg of a geographic route line used herein. In particular, the example data structure below describes two route legs and initial estimated travel times (i.e., durationSeconds) for each of those route legs.

```
[{
    ″start″: {
      ″latitude″: 37.111,
      ″longitude″: −122.222
    },
    ″end″: {
      ″latitude″: 37.222,
      ″longitude″: −122.333
    },
    ″durationSeconds″: 23,
  },
  {
    ″start″: {
      ″latitude″: 37.222,
      ″longitude″: −122.333
    },
    ″end″: {
      ″latitude″: 37.444,
      ″longitude″: −122.555
    },
    ″durationSeconds″: 34,
  },
  ...
]
```

The following describes an example data structure that may be included by the initial service-related data to describe a geographic route line (used herein) based on one or more route legs.

{
″legs″: [ leg0, leg1, ... , legn ]
}

The following describes an example data structure that may be included by the initial service-related data to describe waypoint metadata (e.g., business payload) as used herein. In particular, the example data structure below describes waypoints in connection with two services that may be performed by a provider (e.g., concurrently or sequentially)—a rider service (i.e., “business”: “ride”) for a customer named “Seth” and a freight service (i.e., “business”: “freight”) for a customer named “Karo.”

```
{
  ″waypoints″: [{
        ″waypoint″: ″waypoint-uuid-1″,
        ″actions″: [{
            ″business″: ″ride″,
            ″trip″: ″trip-uuid-1″,
            ″type″: ″pick-up″,
            ″name″: ″Seth″,
            ″customer″: ″customer-uuid-1″
            }],
            ″instruction″: null,
      ″time″: 0
  }]
    },
    {
        ″waypoint″: ″waypoint-uuid-2″,
        ″actions″:
            [{
              ″business″: ″freight″,
              ″trip″: ″trip-uuid-2″,
              ″type″: ″pick-up″,
              ″name″: ″Karo″,
              ″customer″: ″customer-uuid-2″
              }],
              ″instruction″: null,
          ″time″: 0
            }]
    },
    {
        ″waypoint″: ″waypoint-uuid-3″,
        ″actions″: [{
            ″business″: ″ride″,
            ″trip″: ″trip-uuid-1″,
            ″type″: ″dropoff″,
            ″name″: ″Seth″,
        ″customer″: ″customer-uuid-1″
            }],
            ″instruction″: null,
      ″time″: 0
      }]
    },
    {
        ″waypoint″: ″waypoint-uuid-4″,
        ″actions″: [{
            ″business″: ″freight″,
      ″trip″: ″trip-uuid-2″,
            ″type″: ″dropoff″,
            ″name″: ″Karo″,
            ″customer″: ″customer-uuid-2″
            }],
            ″instruction″: null,
      ″time″: 0
        }]
    }
  ]
}
```

The cumulative estimated time data submodule 212 enables or facilitates generation of cumulative estimated time data based on initial service-related data. As noted herein, the cumulative estimated time data may describe a set of estimated travel times for a provider (e.g., one assigned to perform a service for a requester) to travel a set of route legs of a geographic route line described by the initial service-related data. Accordingly, the cumulative estimated time data submodule 212 can initialize estimated times in the cumulative estimated time data structure using the initial service-related data for the requested service (e.g., “durationSeconds” from a data structure describing route legs). As also noted herein, the cumulative estimated time data comprises a data structure (e.g., an array or list) that describes a sequence of estimated times (e.g., estimated travel times or estimated wait times) corresponding to different portions (e.g., route legs or waypoints) of the geographic routing line provided by the initial service-related data.

The route position update data submodule 214 enables or facilitates monitoring for whether route position update data is received at expected times (e.g., according to an expected rate) from a provider client device, and processing of route position update data when received from the provider client device.

The estimated time determination submodule 216 enables or facilitates determination of a set of estimated remaining times for a geographic route line using two or more methodologies that are selected based on whether route position update data is received at expected times from the provider client device (e.g., the client device 122). For instance, in response to the route position update data submodule 214 determining that the route position update data is received at an expected time, the estimated time determination submodule 216 determines a set of estimated remaining times for the geographic route line based on the cumulative estimated time data and the latest route position update data from the provider client device. As noted herein, the set of estimated remaining times can include, without limitation, an estimated travel time remaining for the provider to travel a particular route leg of the geographic route line, and an estimated wait time remaining for the provider to spend at a particular waypoint of the geographic route line (e.g., pick-up waypoint).

On the other hand, in response to the route position update data submodule 214 determining that the route position update data is not received at an expected time, the estimated time determination submodule 216 can determine a set of estimated remaining times for the geographic route line based on the cumulative estimated time data and a geographic location of a requester client device (e.g., after the associated requester has been picked up and is traveling with the provider). Alternatively, in response to the route position update data submodule 214 determining that the route position update data is not received at an expected time, the estimated time determination submodule 216 determines a set of estimated remaining times for the geographic route line based on the cumulative estimated time data and an elapsed time (e.g., elapsed time since receipt of the last route position update from the provider client device).

The display submodule 218 enables or facilitates one or more estimated remaining times, in the set of estimated remaining times, to be displayed on a requester client device (e.g., on a graphical user interface presented on a display of the requester client device), particularly when the cumulative estimated time module 200 is implemented on the request client device (e.g., as part of the requester application 114). For instance, a graphical element displayed on the requester client device on a geographic map may represent a geographic route line (as discussed herein) and the display submodule 218 may cause the one or more estimated remaining times to be displayed in connection with the graphical element.

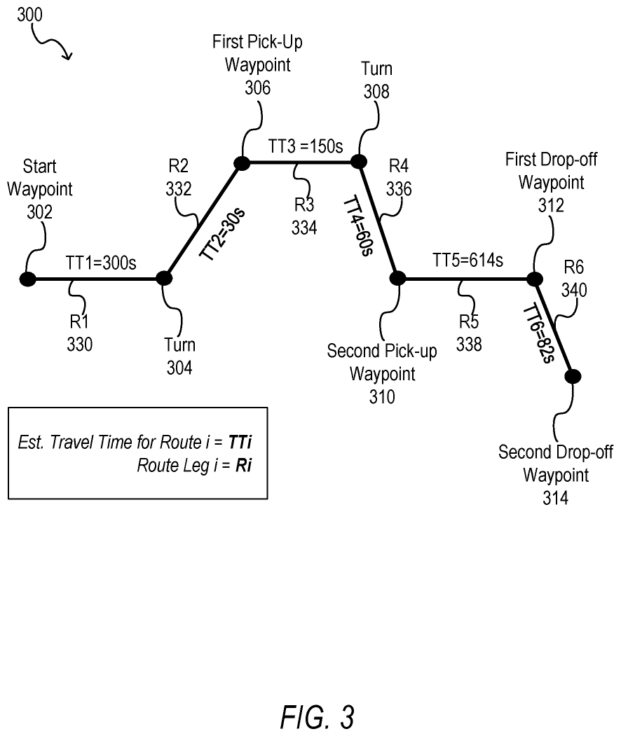

FIG. 3 illustrates an example geographic route line 300 operated upon by some embodiments. As noted herein, the geographic route line 300 is a representation of a geographic route (e.g., navigational route) that a provider may take when performing a service at the request of a requester. For some embodiments, the geographic route line 300 is generated by the networked computer system 100 (e.g., via the geographic route planning module 108) in response to a service, requested by a requester, being dispatched to an available provider. The geographic route line 300 includes nodes 302, 304, 306, 308, 310, 312, 314 and edges 330, 332, 334, 336, 338, 340. Node 302 represents a start waypoint, node 304 represents a navigational turn, node 306 represents a first pick-up waypoint, node 308 represents a turn, node 310 represents a second pick-up waypoint, node 312 represents a first drop-off waypoint, and node 314 represents a second drop-off waypoint. Edge 330 represents a route leg R1, edge 332 represents a route leg R2, edge 334 represents a route leg R3, edge 336 represents a route leg R4, edge 338 represents a route leg R5, and edge 340 represents a route leg R6.

In connection with one or more requested service, the start waypoint (node 302) represents where a provider starts their travel in connection with performing the one or more requested services. For a rideshare service being performed by a provider for a first requester and a second requester, the first pick-up waypoint (node 306) and first drop-off waypoint (node 312) may be associated with the rideshare service for the first requester, while the second pick-up waypoint (node 310) and the second drop-off waypoint (node 314) may be associated with the rideshare service for the second requester. As illustrated, each edge i has an associated estimated travel time. For example, R1 has an estimated travel time of 300 seconds, R2 has an estimated travel time of 30 seconds, R3 has an estimated travel time of 150 seconds, R4 has an estimated travel time of 60 seconds, R5 has an estimated travel time of 614 seconds, and R6 has an estimated travel time of 82 seconds.

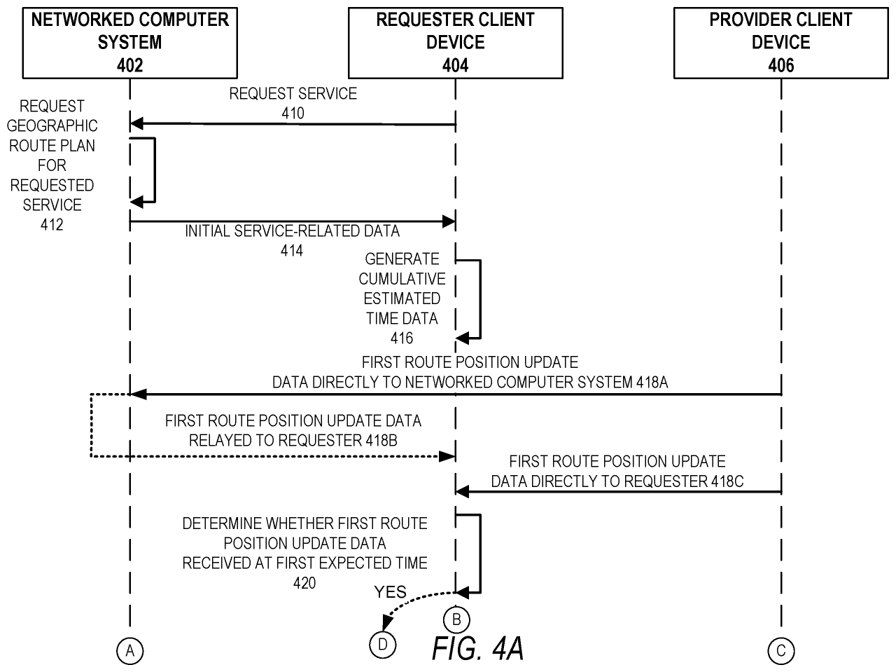

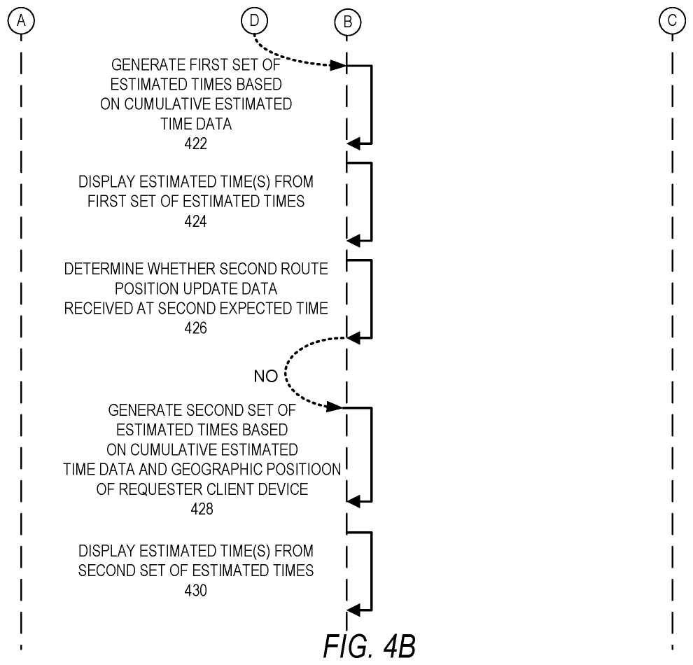

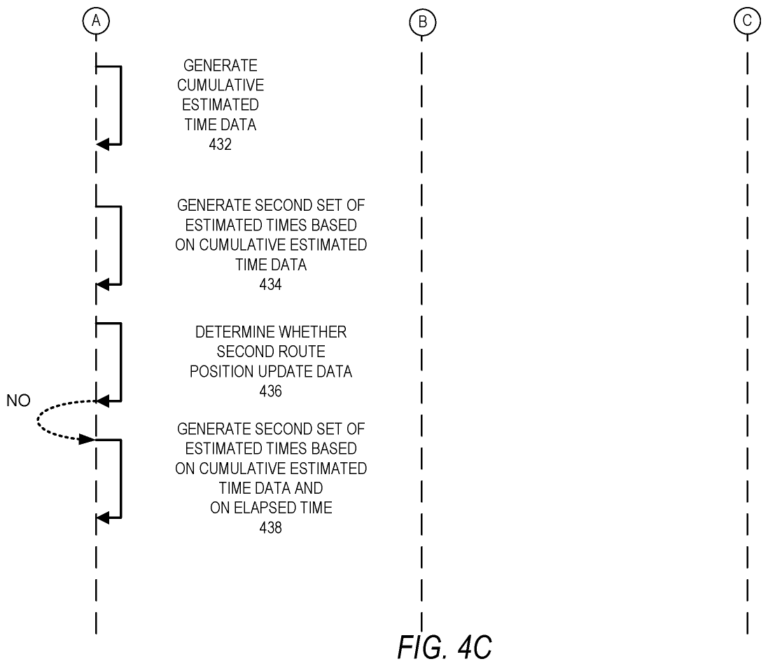

FIGS. 4A-4C provide a diagram illustrating interactions between a networked computer system 402, a requester client device 404, and a provider client device 406, in accordance with some embodiments. For some embodiments, the networked computer system 402, the requester client device 404, and the provider client device 406 are respectively similar to the networked computer system 100, the requester client device 112, and the provider client device 122 described above with respect to FIG. 1. Starting with FIG. 4A, the interactions begin with operation 410 with the requester client device 404 requesting a service for a requester via the networked computer system 402. At operation 412, the networked computer system 402 requests a geographic route plan be generated for the requested service. Depending on the embodiment, the networked computer system 402 requests the geographic route plan after the requested service has been dispatched to an available provider or alternatively, after the dispatched service has been accepted by the available provider. At operation 414, initial service-related data for the requested service is transmitted to the requester client device 404. In turn, at operation 416, the requester client device 404 generates cumulative estimated time data based on the initial service-related data, which subsequently can be used by the requester client device 404 to locally generate one or more estimated time for a geographical route associated with the service requested at operation 410.

For some embodiments, at operation 418A, the provider client device 406 provides (e.g., sends) first route position update data to the networked computer system 402. Subsequently, at operation 418B, the first route position update data may be provided (e.g., relayed) to the requester client device 404. Alternatively (or additionally), at operation 418C, the provider client device 406 provides (e.g., sends) the first route position update data directly to the requester client device 404. As noted herein, the provider client device 406 generates and provides the first route position update data as part of a predetermined rate for refreshing route position update (e.g., route position update data is generated and transmitted by the provider client device 406 every 4 seconds). At operation 420, the requester client device 404 determines whether the first route position update data is received at a first expected time (e.g., according to a 4 second route position update refresh rate).

Referring now to FIG. 4B, at operation 422, in response to determining at operation 420 that the first route position update data is received at the first expected time, the requester client device 404 generates a first set of estimated times based on cumulative estimated time data generated at operation 416. At operation 424, the requester client device 404 displays (e.g., on a graphical user interface of the requester client device 404) one or more estimated times from the first set of estimated times generated at operation 422. Subsequently, at operation 426, the requester client device 404 determines whether second route position update data is received at a second expected time (e.g., according to a 4 second route position update refresh rate). At operation 428, in response to determining at operation 426 that the second route position update data is not received at the second expected time, the requester client device 404 generates a second set of estimated times based on the cumulative estimated time data generated at operation 416 and a geographic position of the requester client device 404. Alternatively, though not shown, if operation 426 had determined that the second route position update data is received at the second expected time, the requester client device 404 would have generated the second set of estimated times based on the cumulative estimated time data generated at operation 416 and the second route position update data. At operation 430, the requester client device 404 displays (e.g., on a graphical user interface of the requester client device 404) one or more estimated times from the second set of estimated times generated at operation 428.

Referring now to FIG. 4C, at operation 432, the networked computer system 402 generates cumulative estimated time data based on the initial service-related data, which subsequently can be used by the networked computer system 402 to locally generate one or more estimated time for the geographical route associated with the service requested at operation 410. At operation 434, the networked computer system 402 generates the second set of estimated times locally (e.g., for use by the networked computer system 402) based on the cumulative estimated time data generated at operation 434. At operation 436, the networked computer system 402 determines whether the second route position update data is received at the second expected time (e.g., according to a 4 second route position update refresh rate). At operation 438, in response to determining at operation 436 that the second route position update data is not received at the second expected time, the requester client device 404 generates the second set of estimated times based on cumulative estimated time data generated at operation 438 and elapsed time since the last instance that the provider client device 406 provided route position update data (e.g., the first route position update data).

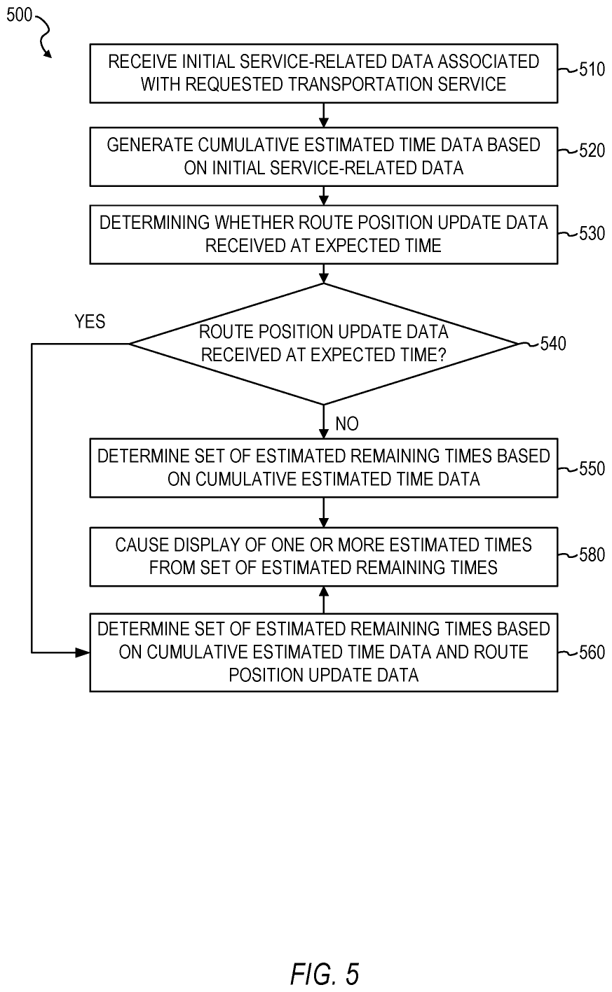

FIG. 5 is a flowchart illustrating an example method 500 for determining estimated times, in accordance with some embodiments. It will be understood that example methods described herein are performed by a computing device, such as a server executing instructions of a delivery or transportation service system. Additionally, example methods described herein may be implemented in the form of executable instructions stored on a computer-readable medium or in the form of electronic circuitry. For instance, the operations of a method 500 of FIG. 5 may be represented by executable instructions that, when executed by a processor of a computing node, cause the computing node to perform the method 500. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel. An operation of the method 500 may be performed by one or more hardware processors (e.g., central processing unit or graphics processing unit) of a computer system.

As shown, the method 500 begins at operation 510 with a computing device (e.g., the networked computer system 100 or the requester client device 112) receiving initial service-related data associated with a requested transportation service being performed by a provider user (e.g., based on a request from the requester client device 112) having a provider client device (e.g., the provider client device 122). As noted herein, the initial service-related data describes a geographic route line comprising a set of route legs connected by a set of waypoints, a set of initial estimated travel times for how long it takes the provider client device to travel the set of route legs, and a set of initial estimated wait times for how long the provider client device will spend at the set of waypoints.

At operation 520, the computing device (e.g., the networked computer system 100 or the requester client device 112) generates cumulative estimated time data based on the initial service-related data received at operation 510. As noted herein, the cumulative estimated time data describes a set of estimated travel times for the provider client device to travel the set of route legs and describes a set of estimated wait times that the provider client device (e.g., the provider client device 122) will spend at the set of waypoints.

At operation 530, the computing device (e.g., the networked computer system 100 or the requester client device 112) determines whether route position update data is received according to an expected time (e.g., predetermined periodicity, such as 4 seconds). As noted herein, route position update data identifies a recent position of the provider client device (e.g., the provider client device 122) relative to the geographic route line described by the initial service-related data received at operation 510. At operation 540, if it is determined that route position update data has not been received according to an expected time, the method 500 proceeds to operation 550; otherwise, the method 500 proceeds to operation 560.

When the method 500 proceeds from operation 540 to operation 550, the computing device (e.g., the networked computer system 100 or the requester client device 112) determines a set of estimated remaining times based on cumulative estimated time data generated at operation 520. Depending on the embodiments, the computing device determines the set of estimated remaining times based on cumulative estimated time data generated at operation 520 and a geographic position of the computing device (e.g., the requester client device 112) or, alternatively, an elapsed time since the last route position update data was received from the provider client device (e.g., the provider client device 122).

When the method 500 proceeds from operation 540 to operation 560, the computing device (e.g., the networked computer system 100 or the requester client device 112) determines the set of estimated remaining times based on cumulative estimated time data generated at operation 520 and route position update data received from the provider client device (e.g., the provider client device 122) by the computing device.

Eventually, at operation 580, the computing device (e.g., the requester client device 112 or the networked computer system 100) causes one or more estimated times, from the set of estimated remaining times (determined by operation 550 or 560), to be displayed at the computing device (e.g., on a graphical user interface of the computing device).

### Example Mobile Device

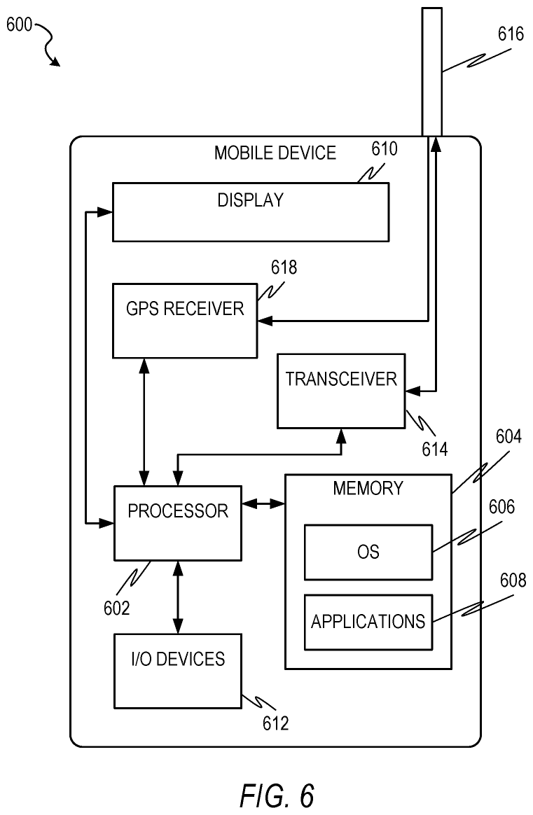

FIG. 6 is a block diagram illustrating an example mobile device 600 used to implement some embodiments. Examples of mobile devices include, without limitation, smartphone, tablet device, and wearable computing devices (e.g., smartwatches). The mobile device 600 can include a processor 602. The processor 602 can be any of a variety of different types of commercially available processors suitable for mobile devices 600 (for example, an XScale architecture microprocessor, a Microprocessor without Interlocked Pipeline Stages (MIPS) architecture processor, or another type of processor). A memory 604, such as a random access memory (RAM), a Flash memory, or other type of memory, is typically accessible to the processor 602. The memory 604 can be adapted to store an operating system (OS) 606, as well as application programs 608, such as a mobile location-enabled application that can provide location-based services (LBSs) to a user. The processor 602 can be coupled, either directly or via appropriate intermediary hardware, to a display 610 and to one or more input/output (I/O) devices 612, such as a keypad, a touch panel sensor, a microphone, and the like. Similarly, in some embodiments, the processor 602 can be coupled to a transceiver 614 that interfaces with an antenna 616. The transceiver 614 can be configured to both transmit and receive cellular network signals, wireless data signals, or other types of signals via the antenna 616, depending on the nature of the mobile device 600. Further, in some configurations, a GPS receiver 618 can also make use of the antenna 616 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In some embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a processor configured using software, the processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Programming Interfaces (APIs).)

### Electronic Apparatus and System

Embodiments may be implemented in digital electronic circuitry, or in computer hardware, firmware, software, or in combinations of them. Embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In some embodiments, operations may be performed by one or more programmable processors executing a computer program to perform functions by operating on input data and generating output. Method operations can also be performed by, and apparatus of some embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various embodiments.

### Example Machine Architecture

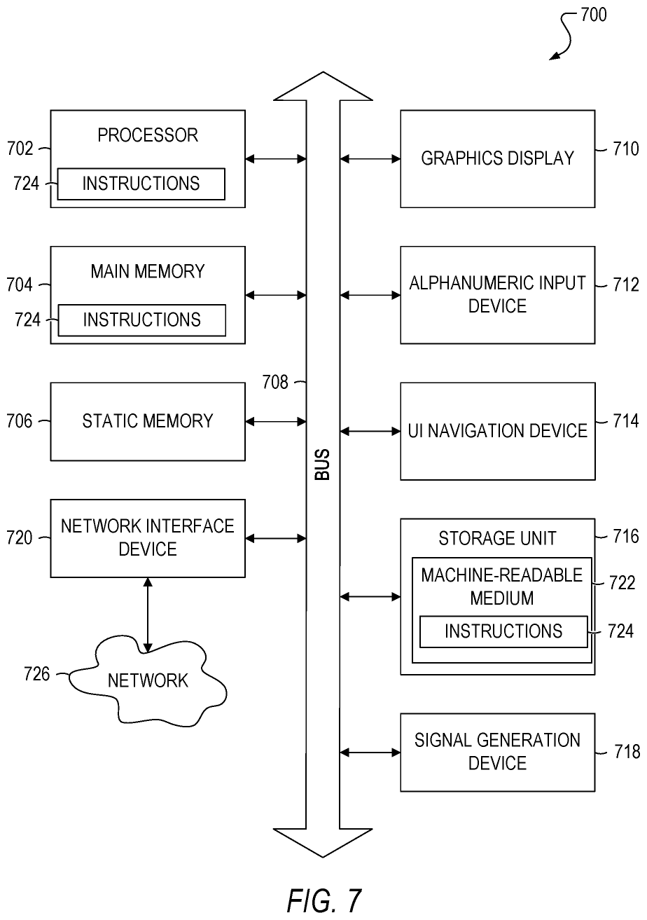

FIG. 7 is a block diagram of an example computer system 700 on which methodologies described herein may be executed, in accordance with some embodiments. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a graphics display unit 710 (e.g., a liquid crystal display (LCD) or a cathode ray tube (CRT)). The computer system 700 also includes an alphanumeric input device 712 (e.g., a keyboard or a touch-sensitive display screen), a user interface (UI) navigation device 714 (e.g., a mouse), a storage unit 716, a signal generation device 718 (e.g., a speaker) and a network interface device 720.

### Machine-Readable Medium

The storage unit 716 includes a machine-readable medium 722 on which is stored one or more sets of instructions and data structures (e.g., software) 724 embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media.

While the machine-readable medium 722 is shown in a particular embodiment to be a single medium, the term “machine-readable medium” may include a single medium or multiple media (e.g., a centralized or distributed database, and/or associated caches and servers) that store the one or more instructions 724 or data structures. The term “machine-readable medium” shall also be taken to include any tangible medium that is capable of storing, encoding or carrying instructions (e.g., the instructions 724) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

### Executable Instructions and Machine-Storage Medium

The various memories (i.e., 704, 706, and/or memory of the processor(s) 702) and/or storage unit 716 may store one or more sets of instructions and data structures (e.g., software) 724 embodying or utilized by any one or more of the methodologies or functions described herein. These instructions, when executed by processor(s) 702, cause various operations to implement the disclosed embodiments.

As used herein, the terms “machine-storage medium,” “device-storage medium,” “computer-storage medium” (referred to collectively as “machine-storage medium 722”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Signal Medium

The term “signal medium” or “transmission medium” in this disclosure shall be taken to include any form of modulated data signal, carrier wave, and so forth. The term “modulated data signal” means a signal that has one or more of its characteristics set or changed in such a manner as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

Although the inventive subject matter has been described with reference to specific embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
receiving, by one or more processors of a computing device, initial service-related data associated with a requested transportation service being performed by a provider user having a provider client device, the initial service-related data describing a geographic route line comprising a set of route legs connected by a set of waypoints, describing a set of initial estimated travel times for how long it takes the provider client device to travel the set of route legs, and describing a set of initial estimated wait times for how long the provider client device will spend at the set of waypoints;
generating, at the computing device, cumulative estimated time data based on the initial service-related data, the cumulative estimated time data describing a set of estimated travel times for the provider client device to travel the set of route legs and describing a set of estimated wait times that the provider client device will spend at the set of waypoints;
determining, by the one or more processors, whether a first route position update data is received at a first expected time, the first route position update data identifying a first recent position of the provider client device relative to the geographic route line; and
in response to determining that the first route position update data is received at the first expected time:
determining, by the one or more processors, a first set of estimated remaining times for the geographic route line based on the cumulative estimated time data and the first route position update data; and
causing, by the one or more processors, display of one or more estimated times, from the first set of estimated remaining times, on a graphical user interface of the computing device.

2. The method of claim 1, further comprising:
in response to determining that the first route position update data is not received at the first expected time:
determining, by the one or more processors, the first set of estimated remaining times based on the cumulative estimated time data and a geographic location of the computing device; and
causing, by the one or more processors, display of the one or more estimated times, from the first set of estimated remaining times, on the graphical user interface of the computing device.

3. The method of claim 1, further comprising:
in response to determining that the first route position update data is not received at the first expected time:
determining, by the one or more processors, time elapsed since receipt of the initial service-related data by the computing device; and
determining, by the one or more processors, the first set of estimated remaining times based on the cumulative estimated time data and the elapsed time.

4. The method of claim 1, further comprising:
determining whether a second route position update data is received at a second expected time, the second route position update data identifying a second recent position of the provider client device relative to the geographic route line; and
in response to determining that the second route position update data is not received at the second expected time:
determining, by the one or more processors, a second set of estimated remaining times for the geographic route line based on the cumulative estimated time data and a geographic location of the computing device; and
causing, by the one or more processors, display of one or more estimated times, from the second set of estimated remaining times, on the graphical user interface of the computing device.

5. The method of claim 4, wherein the determining the second set of estimated remaining times for the geographic route line based on the cumulative estimated time data and the geographic location of the computing device comprises:
determining, by the one or more processors, the geographic location of the computing device;
generating, by the one or more processors, the second route position update data that identifies the second recent position of the provider client device relative to the geographic route line; and
determining, by the one or more processors, the second set of estimated remaining times based on the cumulative estimated time data and the second route position update data.

6. The method of claim 1, further comprising:
determining whether a second route position update data is received at a second expected time, the second route position update data identifying a second recent position of the provider client device relative to the geographic route line; and
in response to determining that the second route position update data is not received at the second expected time:
determining, by the one or more processors, time elapsed since receipt of the first route position update data by the computing device; and
determining, by the one or more processors, a second set of estimated remaining times for the geographic route line based on the cumulative estimated time data and the elapsed time.

7. The method of claim 1, wherein the first route position update data identifies one route leg in the set of route legs and further identifies a relative position of the provider client device relative to the identified one route leg.

8. The method of claim 1, wherein the first route position update data identifies one route leg in the set of route legs and identifies a geographic location of the provider client device.

9. The method of claim 1, wherein the generating the cumulative estimated time data comprises:
determining an accumulated residual time value for one or more estimated times, in the cumulative estimated time data, based on a predetermined unit of granularity; and
adding at least a portion of the accumulated residual time value to a particular estimated time in the cumulative estimated time data.

10. The method of claim 1, further comprising:
sending, by the one or more processors, a request for the requested transportation service, the initial service-related data being received in response to the request.

11. The method of claim 1, wherein the initial service-related data further describes a task for at least one waypoint in the set of waypoints, and wherein at least one estimated wait time, in the set of estimated wait times, comprises an estimated task time to complete the task.

12. The method of claim 1, wherein the requested transportation service comprises at least one of a delivery service or a human transportation service.

13. The method of claim 1, wherein a start waypoint of the geographic route line comprises a present geographic location of the provider client device.

14. The method of claim 1, wherein an end waypoint of the geographic route line comprises a drop-off location for the requested transportation service.

15. The method of claim 1, wherein the set of waypoints comprises at least one intermediate waypoint that connects two route legs in the set of route legs, the at least one intermediate waypoint comprising at least one of a drop-off location for the requested transportation service or a pick-up location for the requested transportation service.

16. The method of claim 1, wherein the set of waypoints comprises at least one intermediate waypoint that connects two route legs in the set of route legs, the at least one intermediate waypoint comprising at least one of a drop-off location for second requested transportation service or a pick-up location for the second requested transportation service, the requested transportation service being requested by a first requester and the second requested transportation service being requested by a second requester.

17. A non-transitory storage medium comprising instructions that, when executed by a hardware processor of a computing device, cause the device to perform operations comprising:
receiving initial service-related data associated with a requested transportation service being performed by a provider user having a provider client device, the initial service-related data describing a geographic route line comprising a set of route legs connected by a set of waypoints, describing a set of initial estimated travel times for how long it takes the provider client device to travel the set of route legs, and describing a set of initial estimated wait times for how long the provider client device will spend at the set of waypoints;
generating, at the computing device, cumulative estimated time data based on the initial service-related data, the cumulative estimated time data describing a set of estimated travel times for the provider client device to travel the set of route legs and describing a set of estimated wait times that the provider client device will spend at the set of waypoints;
determining whether a first route position update data is received at a first expected time, the first route position update data identifying a first recent position of the provider client device relative to the geographic route line; and
determining a first set of estimated remaining times for the geographic route line based on the cumulative estimated time data and the determining whether the first route position update data is received at the first expected time.

18. The non-transitory storage medium of claim 17, wherein the determining whether the first route position update data is received at the first expected time comprises:
in response to determining that the first route position update data is not received at the first expected time, determining the first set of estimated remaining times based on the cumulative estimated time data and a geographic location of the computing device.

19. The non-transitory storage medium of claim 17, wherein the determining whether the first route position update data is received at the first expected time comprises:
in response to determining that the first route position update data is not received at the first expected time, determining the first set of estimated remaining times based on the cumulative estimated time data and elapsed time since receipt of the initial service-related data by the computing device.

20. A computer system comprising:
a memory storing instructions; and
one or more hardware processors configured by the instructions to perform operations comprising:
receiving initial service-related data associated with a requested transportation service being performed by a provider user having a provider client device, the initial service-related data describing a geographic route line comprising a set of route legs connected by a set of waypoints, describing a set of initial estimated travel times for how long it takes the provider client device to travel the set of route legs, and describing a set of initial estimated wait times for how long the provider client device will spend at the set of waypoints;
generating, at the computer system, cumulative estimated time data based on the initial service-related data, the cumulative estimated time data describing a set of estimated travel times for the provider client device to travel the set of route legs and describing a set of estimated wait times that the provider client device will spend at the set of waypoints;
determining whether a first route position update data is received at a first expected time, the first route position update data identifying a first recent position of the provider client device relative to the geographic route line; and
in response to determining that the first route position update data is not received at the first expected time:
determining the first set of estimated remaining times based on the cumulative estimated time data and a geographic location of the computer system; and
causing display of one or more estimated times, from the first set of estimated remaining times, on a graphical user interface of the computer system.
